(19) United States
(12) Patent Application Publication
(10) Pub. No.: US 2023/0031999 A1
(43) Pub. Date: Feb. 2, 2023

(54) EMOTICON GENERATING DEVICE

(71) Applicant: DANAL ENTERTAINMENT CO.,LTD, Gyeonggi-do (KR)

(72) Inventor: You Yeop LIM, Gyeonggi-do (KR)

(73) Assignee: DANAL ENTERTAINMENT CO.,LTD, Gyeonggi-do (KR)

(21) Appl. No.: 17/880,465

(22) Filed: Aug. 3, 2022

Related U.S. Application Data
(63) Continuation of application No. PCT/KR2021/020383, filed on Dec. 31, 2021.

(30) Foreign Application Priority Data
Jul. 27, 2021 (KR) 10-2021-0098517

(51) Int. Cl. G06V 10/77; G06V 10/98; G06F 16/583

(52) U.S. Cl. CPC G06V 10/7715; G06F 16/583; G06V 10/993

(57) ABSTRACT

The present disclosure relates to an emoticon generating device that provides user-customized emoticons. The emoticon generating device includes a user image receiving unit configured to receive a user image from a user terminal, an image analyzing unit configured to analyze the received user image, a background determining unit configured to determine a background image based on the result of analyzing the user image, and an emoticon generating unit configured to generate a synthetic emoticon by synthesizing at least one of a user and an object extracted from the user image with the background image. The background determining unit may determine a background image selected through the user terminal from among at least one of the background images recommended based on the result of analyzing the user image as a background image to be synthesized into the synthetic emoticon.

### CROSS-REFERENCE OF RELATED APPLICATIONS

The Present Application is a continuation of International Application No. PCT/KR2021/020383 filed Dec. 31, 2021 which claims priority to Korean Application No. 10-2021-0098517 filed Jul. 27, 2021, the disclosure of which are incorporated by reference as if they are fully set forth herein.

### TECHNICAL FIELD

The present disclosure relates to an emoticon generating device, and more particularly, to an emoticon generating device that generates user-customized emoticons.

### BACKGROUND

With the spread of smartphones, users’ use of emoticons has increased, and accordingly, emoticons are diversified and the market size thereof is getting bigger. Specifically, emoticons were produced only in the form of static images of characters having various facial expressions in the past, but are recently produced in the form of live-action videos of celebrities, etc. However, in reality, such emoticons may be produced only after passing an evaluation, etc., by emoticon production companies, etc., and there is a limitation in that more diverse emoticons may not be produced due to low awareness, subjective opinions involved in the evaluation process, or an unfair evaluation. Further, users may wish to produce emoticons for themselves, not celebrities, but there is a problem in that it is difficult to produce all of the emoticons preferred by these individuals.

### SUMMARY

The present disclosure is directed to providing an emoticon generating device that provides a user-customized emoticon.

The present disclosure is directed to providing an emoticon generating device that provides a user-customized emoticon with a high degree of completion while a user or an object captured directly by a user appears.

The present disclosure is directed to providing an emoticon generating device that provides a user-customized emoticon more conveniently and promptly.

According to an exemplary embodiment of the present disclosure, an emoticon generating device may include a user image receiving unit for receiving a user image from a user terminal, an image analyzing unit for analyzing the received user image, a background determining unit for determining a background image based on the result of analyzing the user image, and an emoticon generating unit for generating a synthetic emoticon by synthesizing at least one of a user and an object extracted from the user image with the background image, and the background determining unit may determine a background image selected through the user terminal from among at least one background image recommended based on the result of analyzing the user image as a background image to be synthesized into the synthetic emoticon.

The background determining unit may recommend at least one background image based on the result of analyzing the user image, transmit information about the recommended background image (e.g., thumbnail) to the user terminal, and receive the information about the selected background image from the user terminal.

The emoticon generating device may further include a background database storing a plurality of background images to which indices for each of the plurality of background images are mapped.

The background determining unit may acquire a category extracted while analyzing the user image, and acquire a background image mapped to an index coinciding with the extracted category from the background database as a recommended background image.

The image analyzing unit may recognize a user or an object in the user image, and extract a category for the user image by analyzing the recognized user or object.

The image analyzing unit may extract a sample image from the user image at a preset interval, and recognize a user or an object in the extracted sample image.

The image analyzing unit may decide whether a preset unusable condition for each extracted sample image is met when the sample image is extracted, and re-extract a sample image to be used instead of a sample image corresponding to the unusable condition when there is the sample image corresponding to the unusable condition.

The image analyzing unit may re-extract the sample image by changing an interval at which the sample image is extracted.

The image analyzing unit may decide that an image with a user’s eyes closed, an image having a resolution below a preset reference resolution, or an image having a brightness below a preset reference brightness corresponds to the unusable condition.

The emoticon generating unit may determine the size or position of the user or object according to a synthesis guideline set for each background image.

The emoticon generating unit may adjust the size or position of the user or object to be synthesized according to correction information of the synthesis guideline input after the background image is selected through the user terminal.

According to an exemplary embodiment of the present disclosure, when an emoticon generating device receives a user image from a user terminal, the emoticon generating device analyzes the user image and when a user or an object in the user image appears, the emoticon generating device generates an emoticon with appropriate background image synthesized thereto and provides the emoticon to the user terminal, so that there is an advantage in that a synthetic emoticon with a high degree of completion may be provided if a user only captures a user image.

Further, the emoticon generating device provides an opportunity for a user to select a background image when using a synthetic emoticon, which enables to save the size of the data transmitted and received during the process, so that there is an advantage in that an emoticon with high user satisfaction may be generated more quickly.

Further, since the emoticon generating device generates an emoticon by extracting a sample image other than a user image itself, there is an advantage in that the time required for determining a background image may be minimized.

### DESCRIPTION OF DRAWINGS

FIG. 1 is a view illustrating an emoticon generating device system according to an exemplary embodiment of the present disclosure.

FIG. 2 is a control block diagram of the emoticon generating device according to an exemplary embodiment of the present disclosure.

FIG. 3 is a flowchart illustrating an operation method of the emoticon generating device according to an exemplary embodiment of the present disclosure.

FIG. 4 is a flowchart illustrating step S20 of FIG. 3.

FIG. 5 is an exemplary view illustrating an aspect of a method for analyzing a user image by an image analyzing unit according to an exemplary embodiment of the present disclosure.

FIG. 6 is a flowchart illustrating step S210 of FIG. 4.

FIG. 7 is a flowchart illustrating step S30 of FIG. 3.

FIG. 8 is a view illustrating an example of a method of storing a background image in a background database according to an exemplary embodiment of the present disclosure.

FIGS. 9A through 9C are exemplary views illustrating a synthetic emoticon generated by an emoticon generating unit according to an exemplary embodiment of the present disclosure where:

FIG. 9A illustrates a first exemplary synthetic emoticon;

FIG. 9B illustrates a second exemplary synthetic emoticon; and

FIG. 9C illustrates a third exemplary synthetic emoticon.

FIG. 10 is a view illustrating an example in which an emoticon generated by the emoticon generating device according to an exemplary embodiment of the present disclosure is used in a user terminal.

### DETAILED DESCRIPTION

Hereinafter, the present disclosure will be described with reference to the accompanying drawings. However, the present disclosure may be implemented in various different forms, and therefore, is not limited to the exemplary embodiments disclosed herein. And, in order to clearly describe the present disclosure in the drawings, parts irrelevant to the description are omitted, and similar reference numerals are assigned to similar parts throughout the specification.

Throughout the specification, when a part “includes,” or “comprises” a certain element, it means further including other elements rather than excluding other elements, unless specifically stated otherwise.

The terminology used herein is for the purpose of describing particular embodiments only, and is not intended to be limiting of the invention. The singular expression includes the plural expression unless the context clearly indicates otherwise. It should be understood that the terms such as “include,” “comprise,” or “have” throughout this specification, are intended to specify the presence of features, numbers, steps, operations, components, parts, or combinations thereof stated in the specification, but do not preclude the possibility of the presence or addition of one or more other features, numbers, steps, operations, components, parts, or combinations thereof.

Hereinafter, preferred embodiments are presented to help the understanding of the present disclosure, but the preferred embodiments are merely illustrative of the present disclosure, and it will be apparent to those skilled in the art that various changes and modifications are possible within the scope and technical spirit of the present disclosure, and it is certain that such changes and modifications also fall within the scope of the accompanying claims.

Hereinafter, the present disclosure will be described in more detail with reference to the accompanying drawings showing exemplary embodiments of the present disclosure.

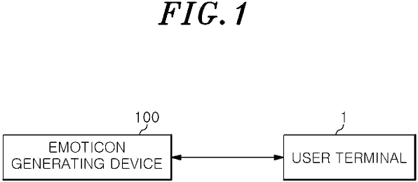

FIG. 1 is a view illustrating an emoticon generating device system according to an exemplary embodiment of the present disclosure.

The emoticon generating device system according to an exemplary embodiment of the present disclosure may include an emoticon generating device 100 and a user terminal 1.

The emoticon generating device 100 may generate a user-customized emoticon. The emoticon generating device 100 may generate the user-customized emoticon and transmit the user-customized emoticon to the user terminal 1, and the user terminal 1 may receive the user-customized emoticon from the emoticon generating device 100.

The user terminal 1 may store and display the user-customized emoticon received from the emoticon generating device 100. A user may easily generate and use the user-customized emoticon by using the user terminal 1 communicating with the emoticon generating device 100.

Hereinafter, a method of generating the user-customized emoticon by the emoticon generating device 100 will be described in detail. Here, the user-customized emoticon may refer to an emoticon generated by synthesizing a user or an object recognized in a user image with a background image selected by the user.

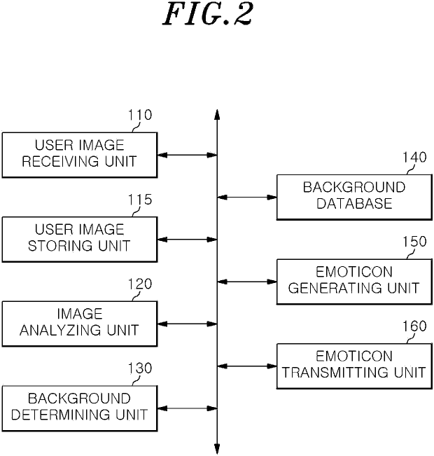

FIG. 2 is a control block diagram of the emoticon generating device according to an exemplary embodiment of the present disclosure.

The emoticon generating device 100 according to an exemplary embodiment of the present disclosure may include at least some or all of a user image receiving unit 110, a user image storing unit 115, an image analyzing unit 120, a background determining unit 130, a background database 140, an emoticon generating unit 150, and an emoticon transmitting unit 160.

The user image receiving unit 110 may receive a user image from the user terminal 1.

The user image may mean a still image or a moving image transmitted from the user terminal 1.

The user image storing unit 115 may store the user image received through the user image receiving unit 110.

The image analyzing unit 120 may analyze the user image received through the user image receiving unit 110.

The background determining unit 130 may determine a background image based on the result of analyzing the user image by the image analyzing unit 120.

Here, the background image may include a still image or a moving image, as background to be used for a synthetic emoticon.

The background determining unit 130 may determine the background image selected by the user terminal 1 from among at least one background image recommended based on the result of analyzing the user image as the background image to be synthesized into the synthetic emoticon.

Specifically, the background determining unit 130 may recommend at least one background image based on the result of analyzing the user image, and transmit the recommended background image to the user terminal 1. At this time, the background determining unit 130 may transmit the background image itself to the user terminal 1, or transmit information about the background image to the user terminal 1.

The information about the background image may be a thumbnail image, text describing the background image, etc., but these are merely exemplary and not limited thereto. As such, when the background determining unit 130 transmits the information about the background image to the user terminal 1, the transmission speed may be improved because the size of transmission data may be reduced compared to when the background image itself is transmitted. Accordingly, there is an advantage in that the speed of generating the synthetic emoticon may be improved.

The user terminal 1 may allow the user to select any one background image by displaying the recommended background image or the information about the recommended background image received from the emoticon generating device 100. The user terminal 1 may transmit the selected background image or the information about the selected background image to the emoticon generating device 100.

When the recommended background image is transmitted to the user terminal 1, the background determining unit 130 may receive the selected background image from among the recommended background image from the user terminal 1. Similarly, when the information about the recommended background image is transmitted to the user terminal 1, the background determining unit 130 may receive the information about the selected background image from the user terminal 1.

The background database 140 may store background images to be used for generating the synthetic emoticon.

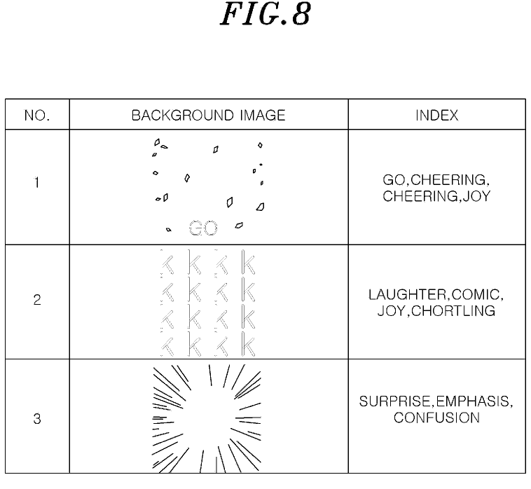

According to an exemplary embodiment, the background database 140 may store a plurality of background images to which indices for each of the plurality of background images are mapped. This part will be described in more detail with reference to FIG. 8.

Meanwhile, the background database 140 may store a synthesis guideline for each of the plurality of background images. The synthesis guideline may refer to the information about the size or position of a user or an object to be synthesized for each background image.

The emoticon generating unit 150 may generate the synthetic emoticon by synthesizing at least one of the user and object extracted from the user image with the background image.

The emoticon generating unit 150 may determine the size or position of the user or object according to the synthesis guideline set for each background image.

Meanwhile, the aforementioned synthesis guideline may also be modified through the user terminal 1. In this case, the emoticon generating unit 150 may adjust the size or position of the user or object to be synthesized according to the correction information of the synthesis guideline input after the background image is selected through the user terminal 1.

The emoticon transmitting unit 160 may transmit the generated synthetic emoticon to the user terminal 1.

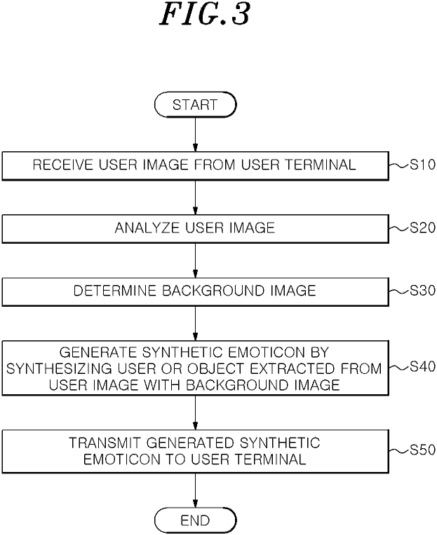

FIG. 3 is a flowchart illustrating an operation method of the emoticon generating device according to an exemplary embodiment of the present disclosure.

The user image receiving unit 110 may receive a user image from the user terminal 1 (S10).

The image analyzing unit 120 may analyze the user image received from the user terminal 1 (S20).

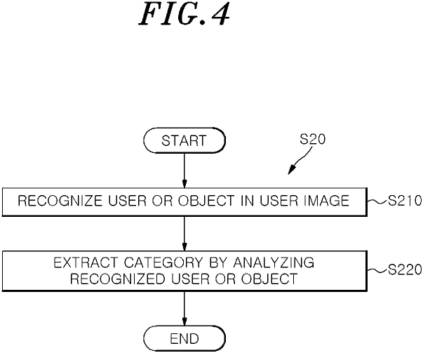

Next, a method of analyzing the user image by the image analyzing unit 120 will be described in more detail with reference to FIG. 4. FIG. 4 is a flowchart illustrating step S20 of FIG. 3.

The image analyzing unit 120 may recognize a user or an object in the user image (S210).

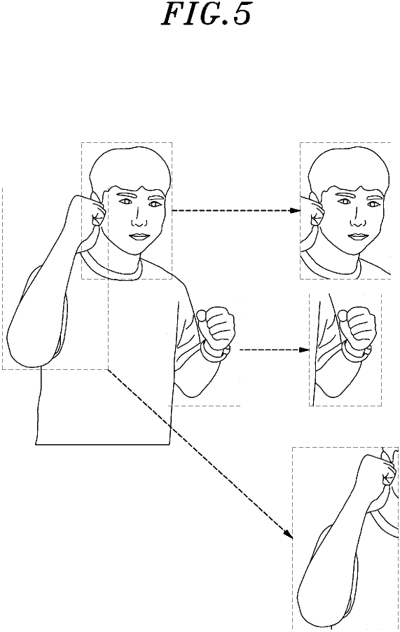

FIG. 5 is an exemplary view illustrating an aspect of a method of analyzing a user image by an image analyzing unit according to an exemplary embodiment of the present disclosure.

According to an exemplary embodiment, the image analyzing unit 120 may analyze the user image by using Vision API. First, the image analyzing unit 120 may detect objects in the user image.

More particularly, the image analyzing unit 120 may recognize objects (e.g., furniture, animals, and food) in the user image through Label Detection, recognize a logo such as a company logo in the user image through Logo Detection, or recognize landmarks such as buildings (e.g., Namsan Tower and Gyeongbokgung) or natural scenery in the user image through Landmark Detection. Further, the image analyzing unit 120 may find a human face in the user image through Face Detection, and analyze facial expressions and emotional states (e.g., happy state, sad state, etc.) by returning positions of eyes, nose, and mouth, etc. Further, the image analyzing unit 120 may detect the degree of risk (or soundness) of the user image through Safe Search Detection, and therefore, may detect the degree to which the user image belongs to adult content, medical content, violent content, etc.

Meanwhile, the image analyzing unit 120 may also recognize the user or object in the entire user image, but may also recognize the user or object in a sample image after extracting the sample image from the user image.

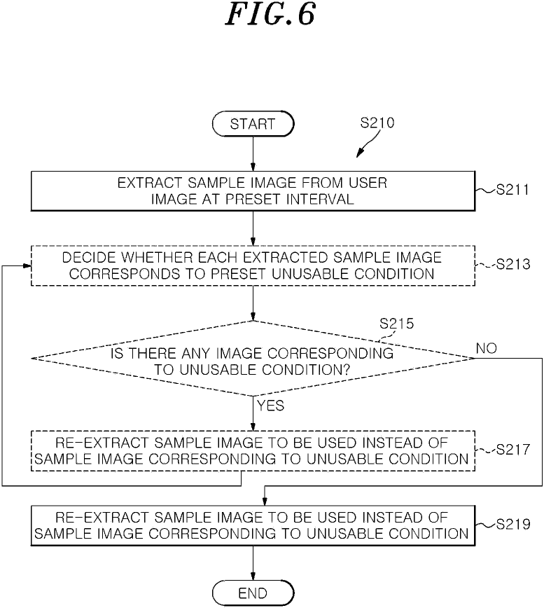

FIG. 6 is a flowchart illustrating step S210 of FIG. 4.

The image analyzing unit 120 may extract the sample image at a preset interval from the user image (S211).

The preset interval may be a time unit or a frame unit.

As an example, the preset interval may be one second, and in this case, if a user image is a five-second image, the image analyzing unit 120 may extract a sample image by capturing the user image at an interval of one second.

As another example, the preset interval may be twenty four frames, and in this case, if a user image is a five-second image in which images of twenty four frames per second are displayed, the image analyzing unit 120 may extract a sample image by capturing the user image at an interval of twenty four frames.

The image analyzing unit 120 may decide whether each extracted sample image corresponds to a preset unusable condition (S213).

As a specific example, the image analyzing unit 120 may decide that an image with a user’s eyes closed, an image having a resolution below a preset reference resolution, or an image having a brightness below a preset reference brightness corresponds to the unusable condition.

The image analyzing unit 120 may decide whether there is an image corresponding to the unusable condition among sample images (S215).

The image analyzing unit 120 may re-extract a sample image to be used instead of the sample image corresponding to the unusable condition if there is an image corresponding to the unusable condition among the sample images (S217).

According to an exemplary embodiment, the image analyzing unit 120 may re-extract the sample image by changing the interval at which the sample image is extracted. As an example, the image analyzing unit 120 may re-extract the sample image at the interval of twenty five frames in step S217, if the image analyzing unit 120 extracts the sample image at the interval of twenty four frames in step S211.

However, since the aforementioned method of changing the sample image extraction interval is merely exemplary, the present disclosure is not limited thereto.

As such, there is an advantage in that the image analyzing unit 120 may generate an emoticon with a higher degree of completion by filtering the image corresponding to the preset unusable condition in advance so as not to be used for generating the emoticon.

When the sample image is re-extracted, the image analyzing unit 120 may decide whether each re-extracted sample image corresponds to the preset unusable condition by returning to step S213.

The image analyzing unit 120 may recognize a user or an object in the (re-)extracted sample image if there is no image corresponding to the unusable condition among the (re-)extracted sample images (S219).

As such, when the user or object is recognized for some sample images extracted from the user image rather than the entire user image, the target of image analysis is reduced, so that there is an advantage in that the time required for background determination may be minimized.

Meanwhile, in FIG. 6, steps S213 and S215 may be omitted according to an exemplary embodiment.

Again, FIG. 4 will be described.

The image analyzing unit 120 may extract a category by analyzing the recognized user or object (S220).

The image analyzing unit 120 may extract features from each of the labeled objects after labeling each of the detected objects. For example, the image analyzing unit 120 may extract features such as joy, sadness, anger, surprise, and confidence after detecting and labeling a face, hand, arm, and eyes from the user image.

In the example of FIG. 5, the image analyzing unit 120 may extract confidence and joy as face image attributes, and may extract fighting as pose attributes. In other words, the image analyzing unit 120 may extract confidence, joy, and fighting as categories corresponding to the example image of FIG. 5.

The category may mean a feature class of the user image classified as a result of analyzing the user image.

Meanwhile, the aforementioned method is merely an example for convenience of description, and the image analyzing unit 120 may also analyze the user image by using other methods other than Vision API.

Again, FIG. 3 will be described.

The background determining unit 130 may determine the background image based on the result of analyzing the user image (S30).

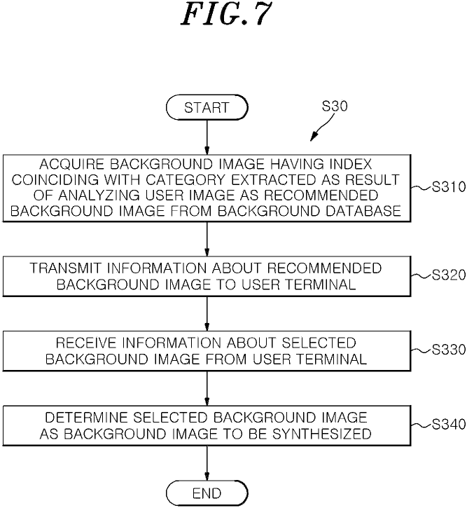

FIG. 7 is a flowchart illustrating step S30 of FIG. 3. In other words, FIG. 7 is a flowchart illustrating a method of determining the background image by the background determining unit 130 according to an exemplary embodiment of the present disclosure.

First, a plurality of background images may be stored in the background database 140, and indices for each of the plurality of background images may be mapped thereto.

FIG. 8 is a view illustrating an example of a method of storing the background images in the background database according to an exemplary embodiment of the present disclosure.

As shown in the example of FIG. 8, the background database 140 includes a plurality of background images, and at least one index is mapped to each of the plurality of background images.

Again, FIG. 7 will be described.

The background determining unit 130 may acquire a background image having an index coinciding with a category extracted as a result of analyzing a user image as a recommended background image from the background database 140 (S31).

As an example, when the category extracted as the result of analyzing the user image is ‘fighting’, the background determining unit 130 may acquire the background image no. 1 as a recommended background image. As another example, when the category extracted as the result of analyzing the user image is ‘joy’, the background determining unit 130 may acquire the background images no. 1 and no. 2 as recommended background images. As still another example, when the category extracted as the result of analyzing the user image is ‘surprise’, the background determining unit 130 may acquire the background image no. 3 as a recommended background image.

Again, FIG. 7 will be described.

The background determining unit 130 may transmit the information about recommended background images to the user terminal 1 (S320).

When the user terminal 1 receives the information about the recommended background images, the user terminal 1 may allow the user to select at least one background image from among the recommended background images by displaying the information about the recommended background images. The user terminal 1 may transmit the information about the selected background image from among the recommended background images to the emoticon generating device 100.

The background determining unit 130 may receive the information about the selected background image from the user terminal 1 (S33).

The background determining unit 130 may determine the selected background image as the background image to be synthesized (S340).

Again, FIG. 3 will be described.

The emoticon generating unit 150 may generate a synthetic emoticon by synthesizing a user or an object extracted from a user image with a background image (S40).

According to an exemplary embodiment of the present disclosure, the emoticon generating unit 150 may generate the synthetic emoticon by synthesizing the user or object extracted from the user image with the background image selected through the user terminal 1, and at this time, the size or position of the user or object may be adjusted according to the synthesis guideline set in the background image. Such synthesis guideline may also be displayed on the user terminal 1 when the user terminal 1 captures the user image for generating an emoticon. Further, the synthesis guideline is displayed even when any one of the recommended background images is selected through the user terminal 1, and in this case, correction information of the synthesis guideline may be input from the user, and when the correction information of the synthesis guidelines is input, the position or size at which the user or object is to be synthesized may also be modified.

Accordingly, there is an advantage in that the emoticon generating device 100 may generate a greater variety of user-customized emoticons.

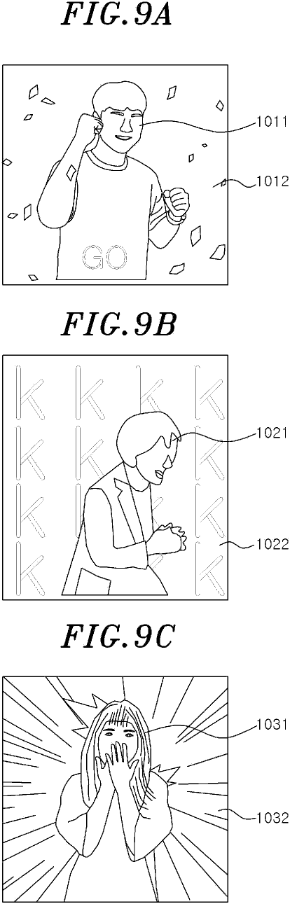

Next, FIGS. 9A through 9C are exemplary views illustrating synthetic emoticons generated by an emoticon generating unit according to an exemplary embodiment of the present disclosure. FIG. 9A illustrates a first exemplary synthetic emoticon. FIG. 9B illustrates a second exemplary synthetic emoticon and FIG. 9C illustrates a third exemplary synthetic emoticon.

As shown in FIGS. 9A through 9C, the emoticon generating unit 150 may generate synthetic emoticons by synthesizing users or objects 1011, 1021, 1031 extracted from user images with background images 1012, 1022, 1032.

Again, FIG. 3 will be described.

The emoticon transmitting unit 160 may transmit the generated synthetic emoticon to the user terminal 1 (S50).

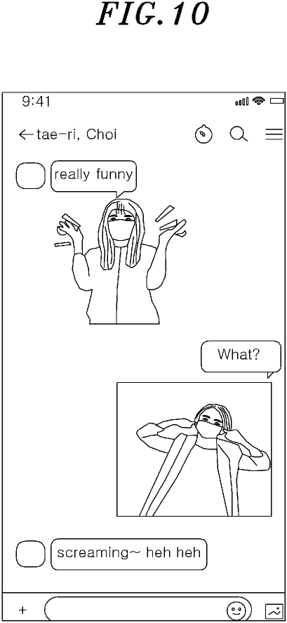

FIG. 10 is a view illustrating an example in which the emoticons generated by the emoticon generating device are used in the user terminal according to an exemplary embodiment of the present disclosure.

As shown in the example in FIG. 10, the user may transmit and receive the synthetic emoticons generated by the emoticon generating device 100 on a messenger through the user terminal 100. Further, although only an example in which emoticons are used in the messenger is illustrated in FIG. 10, the emoticons generated by the emoticon generating device 100 may be used in various applications such as SNS.

The present disclosure described above may be implemented as computer-readable code on a medium in which a program is recorded. The computer-readable medium includes all types of recording devices in which data readable by a computer system is stored. Examples of computer-readable media are a hard disk drive (HDD), solid state disk (SSD), silicon disk drive (SDD), ROM, RAM, CD-ROM, magnetic tape, floppy disk, optical data storage device, etc. Further, the computer may also include components of the emoticon generating device 100. Therefore, the detailed description described above should not be construed as restrictive in all respects but as exemplary. The scope of the present disclosure should be determined by a reasonable interpretation of the accompanying claims, and all modifications within the equivalent scope of the present disclosure are included in the scope of the present disclosure.

1. An emoticon generating device comprising:
a user image receiving unit configured to receive a user image from a user terminal;
an image analyzing unit configured to analyze the received user image;
a background determining unit configured to determine a background image based on a result of analyzing the user image; and
an emoticon generating unit configured to generate a synthetic emoticon by synthesizing at least one of a user and an object extracted from the user image with the background image,
wherein the background determining unit determines a background image selected through the user terminal from among at least one background image recommended based on the result of analyzing the user image as a background image to be synthesized into the synthetic emoticon.

2. The emoticon generating device of claim 1, wherein the background determining unit recommends at least one background image based on the result of analyzing the user image, transmits information about the recommended background image to the user terminal, and receives the information about the selected background image from the user terminal.

3. The emoticon generating device of claim 1, further comprising a background database storing a plurality of background images to which indices for each of the plurality of background images are mapped.

4. The emoticon generating device of claim 3, wherein the background determining unit acquires a category extracted while analyzing the user image, and acquires a background image mapped to an index coinciding with the extracted category from the background database as a recommended background image.

5. The emoticon generating device of claim 1, wherein the image analyzing unit recognizes a user or object in the user image, and extracts a category for the user image by analyzing the recognized user or object.

6. The emoticon generating device of claim 5, wherein the image analyzing unit extracts a sample image from the user image at a preset interval, and recognizes a user or an object in an extracted sample image.

7. The emoticon generating device of claim 6, wherein the image analyzing unit decides whether a preset unusable condition for each extracted sample image is met when the sample image is extracted, and re-extracts a sample image to be used instead of a sample image corresponding to the unusable conditions when there is the sample image corresponding to the unusable condition.

8. The emoticon generating device of claim 7, wherein the image analyzing unit re-extracts the sample image by changing an interval at which the sample image is extracted.

9. The emoticon generating device of claim 7, wherein the image analyzing unit decides that an image with a user’s eyes closed, an image having a resolution below a preset reference resolution, or an image having a brightness below a preset reference brightness corresponds to the unusable condition.

10. The emoticon generating device of claim 1, wherein the emoticon generating unit determines a size or position of the user or object according to a synthesis guideline set for each background image.

11. The emoticon generating device of claim 10, wherein the emoticon generating unit adjusts the size or position of the user or object to be synthesized according to correction information of the synthesis guideline input after the background image is selected through the user terminal.
